(19) United States
(12) Patent Application Publication
(10) Pub. No.: US 2018/0349940 A1
(43) Pub. Date: Dec. 6, 2018

(54) SNS-LINKED REWARD GRANTING SYSTEM, SNS-LINKED REWARD GRANTING METHOD AND SNS-LINKED REWARD GRANTING PROGRAM

(71) Applicant: OPTiM Corporation, Saga-shi (JP)

(72) Inventor: Shunji SUGAYA, Tokyo (JP)

(21) Appl. No.: 16/101,604

(22) Filed: Aug. 13, 2018

Related U.S. Application Data
(63) Continuation-in-part of application No. PCT/JP2016/062980, filed on Apr. 26, 2016.

(51) Int. Cl. G06Q 30/02; G06Q 50/00; H04L 12/58

(52) U.S. Cl. CPC G06Q 30/0236; H04L 51/32; G06Q 50/01; G06Q 30/0239

(57) ABSTRACT

A SNS-linked reward granting system which has a higher adverting effect and is cost-effective for the predetermined product. An SNS-linked reward granting system for granting a reward in conjunction with SNS includes a friend number counting unit that counts a number of friends of an SNS user and an update frequency counting unit that counts an update frequency of articles on a predetermined product, which are written in the SNS by the SNS user. A reward for the predetermined product is granted to the SNS user when the counted number of friends is equal to or more than a predetermined number of people and the counted update frequency is equal to or more than a predetermined frequency.

### CROSS-REFERENCE TO RELATED APPLICATION

This application is a continuation-in-part of PCT Application No. PCT/JP2016/062980filed on Apr. 26, 2016, the entire contents of which are incorporated herein by reference.

### BACKGROUND

### (a) Field

The present invention relates to an SNS-linked reward granting system, an SNS-linked reward granting method, and an SNS-linked reward granting program for granting a reward according to the number of friends and an update frequency in SNS (Social Networking Service).

### (b) Description of the Related Art

In SNS (Social Networking Service) such as Facebook®, Twitter®, mixi®, LINE®, and Instagram®, there is a specific member (hereinafter referred to as a “friend”) that called a friend, a follower or a companion and has a relationship with a user. In the SNS, there is a service that provides limited coupons and contents only to friends of an account such as a store or a commercial service (see Japanese Patent Application Publication No. 2013-008345 (hereinafter referred to as “'345publication”).

However, according to the method of '345 publication, although it is guaranteed that distribution destinations of the limited coupons and contents are always friends of the account such as the store or the commercial service, it does not take into account how much influence the friends have on the SNS. Therefore, there is no guarantee that rewards such as the limited coupons and contents are granted only to real good customers.

Further, in the side of a company that wishes to promote a predetermined product, it is desirable that the introduction of the product by the user is repeated not only once but repeatedly.

As such, there is a technical problem in the existing technology related to the reward granting that the efficiency of the reward granting system is low because the reward granting system cannot provide a technical solution for guaranteeing that the rewards are granted only to real good customers and for making the user repeatedly introduce the product.

### SUMMARY

An aspect of the present invention provides an SNS-linked reward granting system, an SNS-linked reward granting method, and an SNS-linked reward granting program for granting a reward according to the number of friends and an update frequency in SNS.

A first aspect of the present invention provides an SNS-linked reward granting system for granting a reward in conjunction with SNS (Social Networking Service). The SNS-linked reward granting system includes a friend number counting unit that counts a number of friends of an SNS user and an update frequency counting unit that counts an update frequency of articles on a predetermined product, which are written in the SNS by the SNS user, wherein a reward for the predetermined product is granted to the SNS user when the number of friends counted by the friend number counting unit is equal to or more than a predetermined number of people and the update frequency counted by the update frequency counting unit is equal to or more than a predetermined frequency.

According to the first aspect of the present invention, an SNS-linked reward granting system for granting a reward in conjunction with SNS includes a friend number counting unit that counts a number of friends of an SNS user and an update frequency counting unit that counts an update frequency of articles on a predetermined product, which are written in the SNS by the SNS user, and grants a reward for the predetermined product to the SNS user when the number of friends counted by the friend number counting unit is equal to or more than a predetermined number of people and the update frequency counted by the update frequency counting unit is equal to or more than a predetermined frequency.

The invention according to the first aspect is a category of an SNS-linked reward granting system, but exhibits the same action and effect even in an SNS-linked reward granting method and an SNS-linked reward granting program.

A second aspect of the present invention provides, as the SNS-linked reward granting system which is the invention according to the first aspect, the SNS-linked reward granting system wherein the reward is a coupon or a point.

According to the second aspect of the present invention, in the SNS-linked reward granting system which is the invention according to the first aspect, the reward is a coupon or a point.

A third aspect of the present invention provides, as the SNS-linked reward granting system which is the invention according to the first or second aspect, the SNS-linked reward granting system wherein the update frequency counting unit counts only updates of articles whose contents are favorable to the predetermined product.

According to the third aspect of the present invention, in the SNS-linked reward granting system which is the invention according to the first or second aspect, the update frequency counting unit counts only updates of articles whose contents are favorable to the predetermined product.

A fourth aspect of the present invention provides, as the SNS-linked reward granting system which is the invention according to any one of the first to third aspects, the SNS-linked reward granting system wherein the update frequency counting unit counts updates, which are performed a plurality of times a day, only once.

According to the fourth aspect of the present invention, in the SNS-linked reward granting system which is the invention according to any one of the first to third aspects, the update frequency counting unit counts updates, which are performed a plurality of times a day, only once.

A fifth aspect of the present invention provides, as the SNS-linked reward granting system which is the invention according to any one of the first to fourth aspects, the SNS-linked reward granting system wherein the friend number counting unit counts only active friends as the number of friends.

According to the fifth aspect of the present invention, in the SNS-linked reward granting system which is the invention according to any one of the first to fourth aspects, the friend number counting unit counts only active friends as the number of friends.

A sixth aspect of the present invention provides an SNS-linked reward granting method for granting a reward in conjunction with SNS, including counting a number of friends of an SNS user and counting an update frequency of articles on a predetermined product, which are written in the SNS by the SNS user, wherein a reward for the predetermined product is granted to the SNS user when the number of friends counted in the friend number counting step is equal to or more than a predetermined number of people and the update frequency counted in the update frequency counting step is equal to or more than a predetermined frequency.

A seventh aspect of the present invention provides a program for causing an SNS-linked reward granting method for granting a reward in conjunction with SNS to execute counting a number of friends of an SNS user and counting an update frequency of articles on a predetermined product, which are written in the SNS by the SNS user, wherein a reward for the predetermined product is granted to the SNS user when the number of friends counted in the friend number counting step is equal to or more than a predetermined number of people and the update frequency counted in the update frequency counting step is equal to or more than a predetermined frequency.

An eighth aspect of the present invention provides an SNS-linked reward granting system for granting a reward in conjunction with SNS, including a friend number counting unit that counts a number of only active friends among friends of an SNS user, the active friends each having made a comment or reaction in the SNS within a predetermined period of time, and an update frequency counting unit that counts an update frequency of articles on a predetermined product, which are written in the SNS by the SNS user, wherein a reward for the predetermined product is granted to the SNS user when the number of friends counted by the friend number counting unit is equal to or more than a predetermined number of people and the update frequency counted by the update frequency counting unit is equal to or more than a predetermined frequency, and wherein in a case where the SNS user uses a plurality of SNSs, the friend number counting unit counts the number of friends by a total sum of the number of active friends in each of the plurality of SNSs, and counts, when a same friend exists in multiple SNSs, duplicate friends only once.

According to the eighth aspect of the present invention, because the number of only active friends is counted among friends of an SNS user and an update frequency of articles on a predetermined product, which are written in the SNS by the SNS user, is counted so that a reward for the predetermined product is granted to the SNS user when the number of friends is equal to or more than a predetermined number of people and the update frequency is equal to or more than a predetermined frequency, the SNS-linked reward granting system can guarantee that the reward is granted only to a real good customer such as the SNS user having many active friends and updating many articles, and can make the SNS user repeatedly update the articles on the product. Accordingly, the eighth aspect of the present invention can provide a technical solution for guaranteeing that the rewards are granted only to real good customers and for making the user repeatedly introduce the product, thereby improving the efficiency of the SNS-linked reward granting system.

According to an aspect of the present invention, an SNS-linked reward granting system, an SNS-linked reward granting method, and an SNS-linked reward granting program for granting a reward according to the number of friends and update frequency in SNS.

### BRIEF DESCRIPTION OF THE DRAWINGS

FIG. 1 is a drawing an overview of an embodiment of the present invention.

FIG. 2 is a diagram showing functional blocks of a user terminal 100 and a server 200 and a relationship between the respective functions.

FIG. 3 is a flowchart of an SNS-linked reward granting process in a user terminal 100 and a server 200.

FIG. 4 is a diagram showing functional blocks of a user terminal 100 and a server 200 and a relationship between the respective functions in a case where the number of friends and update frequency are counted at a side of the user terminal 100.

FIG. 5 is a flowchart of an SNS-linked reward granting process in a case where the number of friends and an update frequency are counted at a side of the user terminal 100.

FIG. 6 is a flowchart of a process of counting the number of friends.

FIG. 7 is a flowchart of a process of counting an update frequency of articles on a predetermined product.

FIG. 8 is an example of a screen in a case of updating an article on a predetermined product in SNS.

### DETAILED DESCRIPTION OF THE EMBODIMENTS

Hereinafter, embodiments for carrying out the present invention are described with reference to the drawings. It is to be understood that the embodiments are merely examples and the scope of the present invention is not limited to the disclosed embodiments.

### Overview of SNS-Linked Reward Granting System

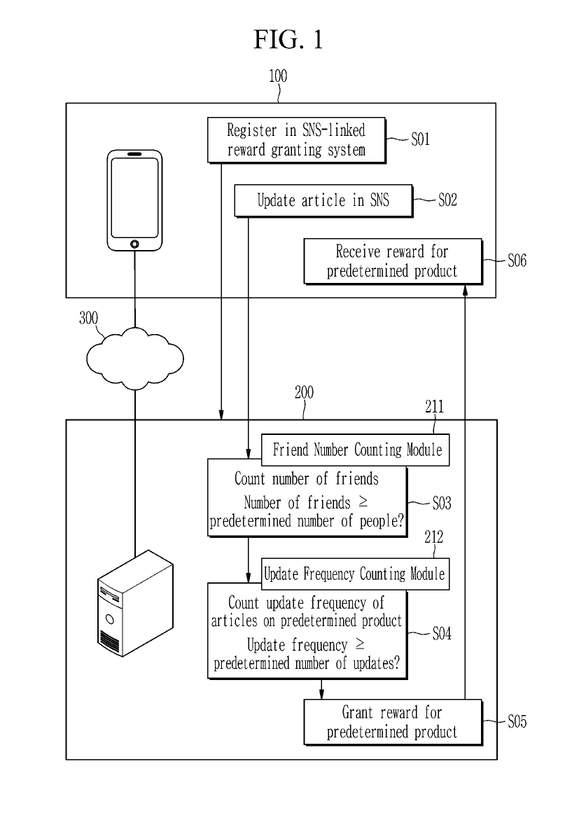

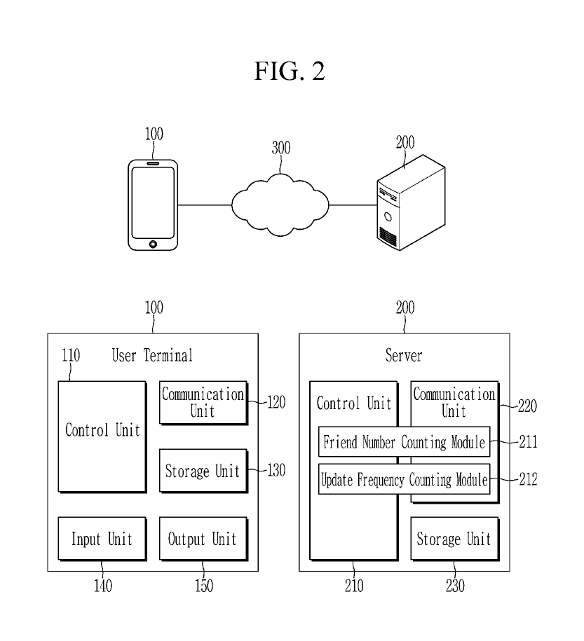

An overview of an SNS-linked reward granting system according to an embodiment of the present invention is described with reference to FIG. 1. A user terminal 100 and a server 200 can communicate via a communication network 300 such as the Internet. As shown in FIG. 2, the user terminal 100 includes a control unit 110, a communication unit 120, a storage unit 130, an input unit 140, and an output unit 150. As shown in FIG. 2, the server 200 includes a control unit 210, a communication unit 220, and a storage unit 230. The control unit 210 realizes a friend number counting module 211 and an update frequency counting module 212 in cooperation with the communication unit 220. The communication network 300 may be a public communication network such as the Internet or a dedicated communication network.

In the SNS-linked reward granting system, the user terminal first registers user information in the SNS-linked reward granting system (step S01). Here, the user information is necessary information, such as a type of SNS being used or an account of the SNS, for the SNS-linked reward granting system to acquire the number of friends of a user or an update frequency of articles. At the time of registration in the system, the user may decide a predetermined product for which the user wants to receive a reward. Alternatively, the user may select the predetermined product for which the user wants to receive the reward at appropriate time.

Next, the user terminal 100 updates an article on the predetermined product in the registered account of the SNS (step S02). Here, at the time of updating the article, information capable of specifying the predetermined product, such as a name of the predetermined product or a URL related to the predetermined product, is included.

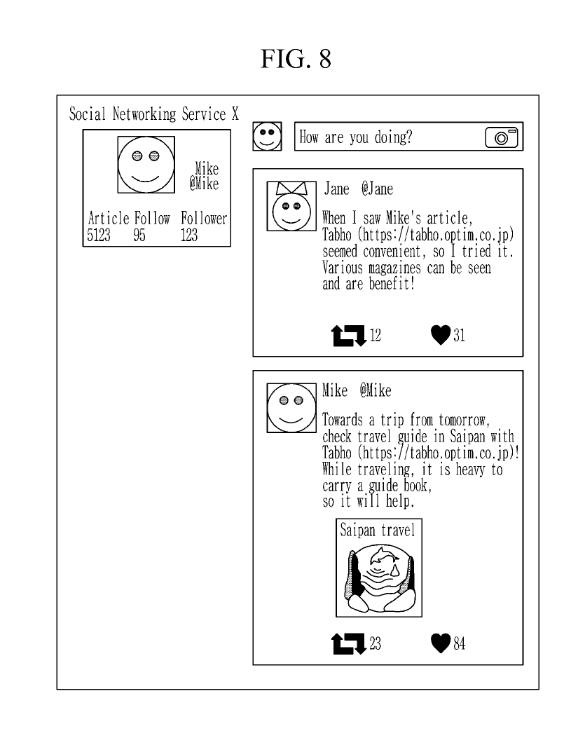

FIG. 8 is an example of a screen in a case of updating an article on a predetermined product in SNS. In SNS of a type “Social Networking Service X”, a case where a user having an account “Mike” updates an article about “Tabho®” which is a predetermined product is shown as an example. A profile column at the top left of a screen shows that Mike has updated articles 5123 times so far, there are 123 followers who are equivalent to friends, and Mike follows 95 people. Further, a timeline at the right side of the screen displays articles updated by Mike and users following Mike. Here, an example that the articles are displayed in chronological order and the latest articles are placed on top is shown. The example shows that after Mike updates an article about an electronic journal service named Tabho which is the predetermined product, Jane, a friend of Mike, sees the article, and then uses Tabho and updates the article. For Mike's article, 23, which is a number placed to the right of an arrow mark shown at the bottom of the article, is the number of users who like the Mike's article and have shared the Mike's article to be displayed on their own timelines, and 84, which is a number placed to the right side of a heart mark, is the number of users who have made a favorable reaction “Like” to the article. Here, the name of the predetermined product and the URL relating to the predetermined product, which are information that can specify the predetermined product, are “Tabho” and “https://tabho.optim.co.jp”, respectively.

The friend number counting module 211 of the server 200 counts the number of friends for the registered SNS account of the user terminal 100 at a predetermined timing (step S03). Here, when counting the number of friends, the friend number counting module 211 may check whether the friends are active friends on the SNS and count only the active friends. Whether it is active or not means whether the friend currently uses the SNS, and may be determined in accordance with whether the friend has exchanged a message with the user within a certain period of time, whether the friend has made comments on the user's articles or reactions, such as “like”, on the user's articles within a certain period of time, whether the friend has updated an article within a certain period of time, or the like. A predetermined number of people in the number of friends may be determined according to the predetermined product by the system and may be, for example, 50 or more people or 100 or more people.

When the number of friends is equal to or more than the predetermined number of people, the update frequency count module 212 of the server 200 counts a frequency of updating the articles for the predetermined product (step S04). Here, when counting the frequency of updating the articles, the update frequency count module 212 may count only the articles whose contents are favorable to the predetermined product. Further, for example, a case where updating are performed a plurality of times per day may be counted only once, or a case where updating are performed a plurality of times within a certain period of time may be counted only once. In an example of FIG. 8, it may be checked whether the content of the article relates to the predetermined product by using the name “Tabho” of the predetermined product or the URL “https://tabho.optim.co.jp” relating to the predetermined product as a keyword. It may be determined whether the content of the article is favorable by analyzing words or contexts included in the article of the predetermined article. In the article of Mike in FIG. 8, whether the article is favorable may be determined by the word and the context “help”. Furthermore, when determining whether Jane's article is favorable, it may be determined that the article is favorable, by words or contexts such as “convenience”, “benefit”, and the like. Here, the word registration or context analysis used for determining the content does not particularly limit the present invention and the existing technology may be used.

As a result of counting the update frequency, when the update frequency of the articles concerning the predetermined product is the predetermined frequency or more, the server 200 grants a reward for the predetermined product to the user terminal 100 (step S05). Here, the term “the predetermined frequency or more” may be determined according to the predetermined product by the system and may be, for example, 10 times or more for the past month or 3 times or more for the past one week. Further, the reward for the predetermined product here may be a coupon or point that can be used for the predetermined product. For example, when the predetermined product is a certain paid web service, a point that can be used for the paid web service, one-year free license code, or the like is considered as the reward.

Finally, the user terminal 100 receives the reward for the predetermined product at the registered SNS account (step S06).

As described above, according to the present invention, when a user having a large number of friends and having an influence on the SNS updates articles for a predetermined product more than the predetermined frequency, it is possible to provide an SNS-linked reward granting system, an SNS-linked reward granting method, and an SNS-linked reward granting program that can grant a reward for the predetermined product, and are cost-effective for a company that wants to advertise the predetermined product.

### Description of Functions

FIG. 2 is a diagram showing functional blocks of a user terminal 100 and a server 200 and a relationship between the respective functions in an SNS-linked reward granting system according to an embodiment of the present invention. The user terminal 100 and the server 200 can communicate via a communication network 300. The user terminal 100 includes a control unit 110, a communication unit 120, a storage unit 130, an input unit 140, and an output unit 150. The server 200 includes a control unit 210, a communication unit 220, and a storage unit 230. The control unit 210 realizes a friend number counting module 211 and an update frequency counting module 212 in cooperation with the communication unit 220. The communication network 300 may be a public communication network such as the Internet or a dedicated communication network.

The user terminal 100 may be a general information terminal that allows a user to browse a web page such as SNS and to execute various applications, and is an information device or an electric appliance having functions to be described later. The user terminal 100 may be a general information appliance such as a mobile phone, a smartphone, a tablet PC, a notebook PC, a wearable device, or a PC equipped with a display; a network appliance such as a complex type printer, a television, a router or a gateway; a home appliance such as a refrigerator or a washing machine; an electric appliance such as a telephone, a netbook terminal, a slate terminal, an electronic book terminal, an electronic dictionary terminal, a portable music player, a portable content playback/recording player; or the like. A smartphone shown as the user terminal 100 is merely an example. Further, while only one smartphone is shown as the user terminal 100, a user may use a plurality of terminals if the user can be specified by a type of SNS and an account of SNS.

The user terminal 100 includes, as the control unit 110, a processor such as a CPU (Central Processing Unit), a RAM (Random Access Memory), a ROM (Read Only Memory), and the like.

Further, the user terminal 100 includes, as the communication unit 120, a communication device for enabling communication with another device, for example, a WiFi (Wireless Fidelity) compliant device conforming to IEEE 802.11 or a wireless device conforming to the IMT-2000 standard such as a third generation mobile communication system. The communication unit 120 may uses a wired LAN connection.

The user terminal 100 includes, as the storage unit 130, a data storage device such as a hard disk or a semiconductor memory. The storage unit 130 may store necessary information and the like.

The input unit 140 has a function necessary for updating articles in the SNS. For example, the input unit 140 may have a liquid crystal display for realizing a touch panel function, a keyboard, a mouse, a pen tablet, a hardware button on a device, a microphone for performing voice recognition, or the like. The function of the present invention is not limited in particular by an input method.

The output unit 150 has a function necessary for displaying the SNS and the like. For example, the output unit 150 may have a screen display such as a liquid crystal display, a display of a PC, a projection to a projector, or the like, or a sound output such as a speaker, a headphone, an earphone, or the like. The function of the present invention is not limited in particular by an output method.

The server 200 may be a general server having functions to be described later.

The server 200 includes a processor such as a CPU, a RAM, a ROM, and the like as the control unit 210.

Further, the server 200 includes, as the communication unit 220, for example, a communication device such as a WiFi compliant device conforming to IEEE 802.11 or a wireless device conforming to the IMT-2000 standard such as a third generation mobile communication system. The communication unit 220 may use a wired LAN connection.

In the server 200, when the control unit 210 reads a predetermined program, thereby realizing a friend number count module 211 and an update frequency count module 212 in cooperation with the communication unit 220.

The server 200 includes, the storage unit 230, as a data storage device such as a hard disk or a semiconductor memory. The storage unit 230 may store information such as a type of SNS of the user terminal 100, an account of the SNS, the number of friends, an update frequency, and the like, necessary for the SNS-linked reward granting system.

### SNS-Linked Reward Granting Process

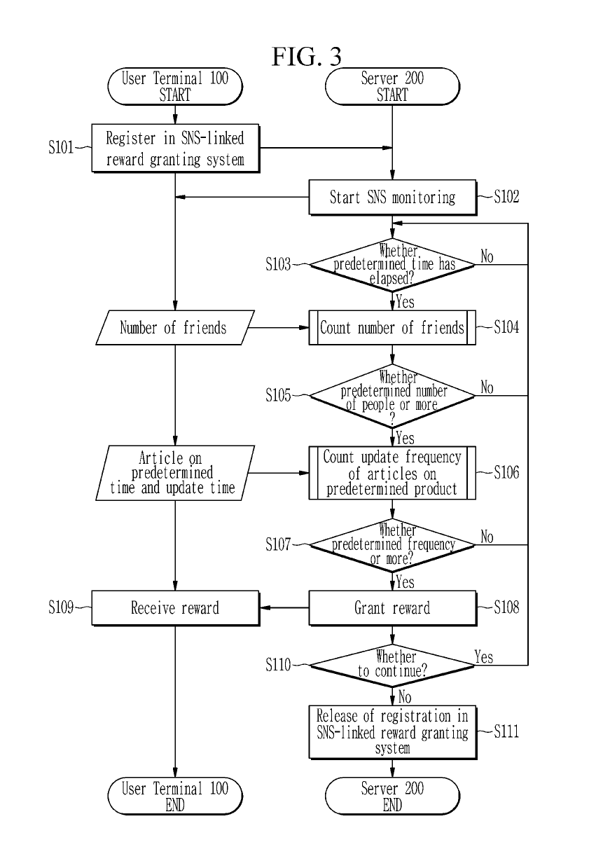

FIG. 3 is a flowchart of an SNS-linked reward granting process in a user terminal 100 and a server 200 according to an embodiment of the present invention. The processing executed by modules of each device described is described together with this processing. The user terminal 100 and the server 200 can communicate via a communication network 300. The communication network 300 may be a public communication network such as the Internet or a dedicated communication network.

First, the user terminal 100 transmits user information inputted by the input unit 140 to the server 200 via a communication unit 120, and registers the user information in an SNS-linked reward granting system (step S101). Here, it is assumed that the user information is necessary information, such as a type of SNS being used, an account of the SNS or the like, for the SNS-linked reward granting system to acquire the number of friends of the user and an update frequency of articles. At the time of registration in the system, the user may decide a predetermined product for which the user wants to receive a reward. Alternatively, the user may select the predetermined product for which the user wants to receive the reward at appropriate time. The server 200 may be provided with a web page for registration or the like so that the user can easily perform the registration in the SNS-linked reward granting system.

Next, the server 200 starts SNS monitoring of the registered user based on the registered user information via a communication unit 220 (step S102). Here, the method for starting the SNS monitoring of the registered user does not particularly limit the present invention and the existing technology may be used.

While it has not been shown in the flowchart, after registration in the SNS-linked reward granting system in step S101, the user can update an article for the predetermined product at an account of the registered SNS through the user terminal 100 at a desired timing. Here, at the time of updating the article, information, which can specify the predetermined product, such as a name of the predetermined product or a URL related to the predetermined product is included.

FIG. 8 is an example of a screen in a case of updating an article on a predetermined product in SNS. In SNS of a type “Social Networking Service X”, a case where a user having an account “Mike” updates an article about “Tabho” which is a predetermined product is shown as an example. A profile column at the top left of a screen shows that Mike has updated articles 5123 times so far, there are 123 followers who are equivalent to friends, and Mike follows 95 people. Further, a timeline at the right side of the screen displays articles updated by Mike and users following Mike. Here, an example that the articles are displayed in chronological order and the latest articles are placed on top is shown. The example shows that after Mike updates an article about an electronic journal service named Tabho which is the predetermined product, Jane, a friend of Mike, sees the article, and then uses Tabho and updates the article. For Mike's article, 23, which is a number placed to the right of an arrow mark shown at the bottom of the article, is the number of users who like the Mike's article and have shared the Mike's article to be displayed on their own timelines, and 84, which is a number placed to the right side of a heart mark, is the number of users who have made a favorable reaction “Like” to the article. Here, the name of the predetermined product and the URL relating to the predetermined product, which are information that can specify the predetermined product, are “Tabho” and “https://tabho.optim.co.jp”, respectively.

After starting the SNS monitoring of the registered user, a control unit 210 of the server 200 checks whether a predetermined time has elapsed (step S103). When the predetermined time has elapsed, a friend number counting module 211 counts the number of friends for the registered SNS account of the user terminal 100 (step S104). When the predetermined time has not elapsed, the process returns to step S103 again. While it has not been shown here, it is assumed that wait processing may be appropriately performed according to the system before returning to step S103.

When counting the number of friends in step S104, it may be checked whether the friends are active friends on the SNS, and only active friends may be counted. Whether it is active or not means whether the friend currently uses the SNS, and may be determined in accordance with whether the friend has exchanged a message with the user within a certain period of time, whether the friend has made comments on the user's articles or reactions, such as “like”, on the user's articles within a certain period of time, whether the friend has updated an article within a certain period of time, or the like. The details of the process of counting the number of friends of SNS are described later.

After counting the number of friends, the friend number counting module 211 checks whether the number of friends is equal to or more than a predetermined number of people (step S105). The predetermined number of people may be determined according to the predetermined product by the system and may be, for example, 50 or more people or 100 or more people.

When the number of friends is equal to or more than the predetermined number of people, an update frequency count module 212 of the server 200 counts an update frequency of articles for the predetermined product (step S106). Here, when confirming the update frequency of the articles, the update frequency count module 212 may count only the articles whose contents are favorable to the predetermined product. Further, for example, a case where updating are performed a plurality of times per day may be counted only once, or a case where updating are performed a plurality of times within a certain period of time may be counted only once. The details of the process of confirming the update frequency of the articles on the predetermined product are described later. When the number of friends is less than the predetermined number of people, the process returns to step S103.

In the example of FIG. 8, it may be checked whether the content of the article relates to the predetermined product by using the name “Tabho” of the predetermined product or the URL “https://tabho.optim.co.jp” relating to the predetermined product as a keyword. Whether the content of the article is favorable may be determined by analyzing words or contexts included in the article of the predetermined article. In the article of Mike in FIG. 8, whether the article is favorable may be determined by the word and the context such as “help”. Furthermore, when determining whether Jane's article is favorable, it may be determined that the article is favorable, by words or contexts such as “convenience”, “benefit”, and the like. Here, the word registration or context analysis used for determining the content does not particularly limit the present invention and the existing technology may be used.

After counting the update frequency, the update frequency count module 212 checks whether the update frequency is equal to or more than a predetermined frequency (step S107).

When the update frequency of articles on the predetermined product is equal to or more than the predetermined frequency, the server 200 grants a reword for the predetermined product to the user terminal 100 (step S108). Here, “the predetermined frequency or more” is determined by the update frequency within a predetermined period. For example, “the predetermined frequency or more” may be 10 times or more for the past month or 3 times or more for the past one week, and may be determined according to the predetermined product by the system. The predetermined time in step S103 needs to be equal to or shorter than the predetermined period. When the predetermined time is shorter than the predetermined period, the update frequency within the predetermined time is stored in the storage unit 230 so that the update frequency within the predetermined period can be check in step S107. Further, the reward for the predetermined product here may be a coupon or point that can be used for the predetermined product. For example, when the predetermined product is a certain paid web service, a point that can be used for the paid web service, one-year free license code or the like is considered as the reward. When the update frequency of the articles on the predetermined product is less than the predetermined frequency, the process returns to step S103.

The user terminal 100 receives the reward for the predetermined product at the account of the registered SNS (step S109). The received reward may be used at a timing desired by the user.

After granting the reward, the server 200 checks whether to continue the SNS-linked reward granting process (step S110). The SNS-linked reward granting system may set whether the SNS-linked reward granting process can be continued after the reward is granted, in advance, according to the predetermined product and the content of the reward. For example, when the reward is a long-time free license code or the like, there is no need to continue the SNS-linked reward granting process, so the registration in the SNS-linked reward granting system is released (step S111). When the reward is a point or the like that can be used for the paid web service, the SNS-linked reward granting process may be continued. In a case of continuing, the process returns to step S103 and continues the processing. Here, a condition for continuing the process, such as, for example, the continuation being impossible after the reward is granted three times, may be set according the system. In addition, the registration release in the SNS-linked reward granting system may be performed at any time by a release request from the user terminal 100.

It has been described in the flowchart of FIG. 3 that the user registers one type of SNS. However, if the user uses a plurality of SNSs, the number of friends may be counted by a total sum of the number of friends in each of the SNSs. In this case, it is necessary to post the article to each SNS. Further, if the same friend exists in multiple SNSs, duplicate friends may be counted only once.

As described above, according to the present invention, when a user having a large number of friends and having an influence on the SNS updates articles on a predetermined product more than the predetermined frequency, it is possible to provide an SNS-linked reward granting system, an SNS-linked reward granting method, and an SNS-linked reward granting program that can grant a reward for the predetermined product, and are cost-effective for a company that wants to advertise the predetermined product. In other words, the SNS-linked reward granting system can guarantee that the reward is granted only to a real good customer such as the SNS user having many active friends or updating many articles, and can make the SNS user repeatedly update the articles on the product. Accordingly, the efficiency of the SNS-linked reward granting system can be improvded.

### SNS-Linked Reward Granting Process for Counting Number of Friends and Update Frequency at User Terminal Side

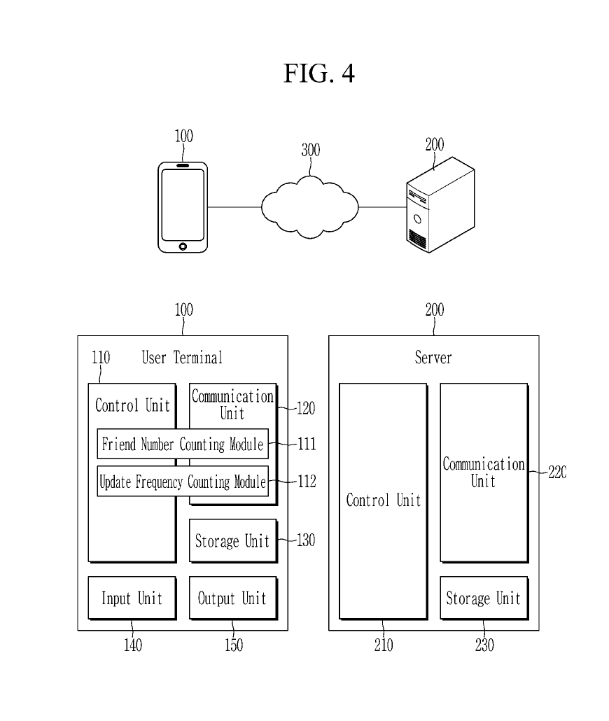

FIG. 4 is a diagram showing functional blocks of a user terminal 100 and a server 200 and a relationship between the respective functions in a case where the number of friends and an update frequency are counted at the side of the user terminal 100. The user terminal 100 and the server 200 can communicate via a communication network 300. The user terminal 100 includes a control unit 110, a communication unit 120, a storage unit 130, an input unit 140, and an output unit 150. The control unit 110 realizes a friend number counting module 111 and an update frequency counting module 112 in cooperation with the communication unit 220. The server 200 includes a control unit 210, a communication unit 220, and a storage unit 230. The communication network 300 may be a public communication network such as the Internet or a dedicated communication network.

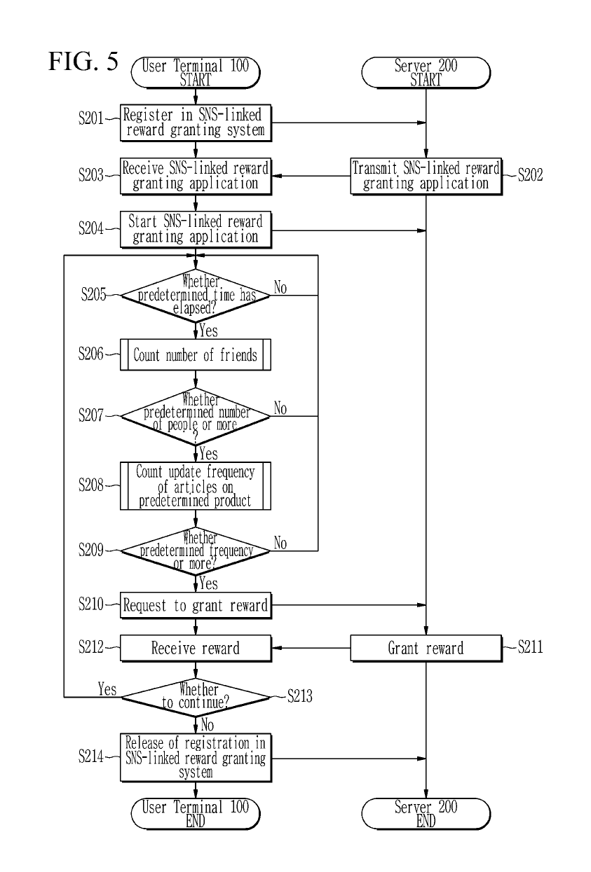

FIG. 5 is a flowchart of an SNS-linked reward granting process in a case where the number of friends and an update frequency are counted at the side of the user terminal 100.

First, the user terminal 100 transmits a request for registration in the SNS-linked reward granting system to the server 200 via the communication unit 120 (step S201). At this time, the user information may be transmitted together, or may be transmitted at the start of the SNS-linked reward granting application in step S204 described later. Here, it is assumed that the user information is necessary information, such as a type of SNS being used, an account of the SNS or the like, for the SNS-linked reward granting system to acquire the number of friends of the user and an update frequency of articles. At the time of registration in the system, the user may decide a predetermined product for which the user wants to receive a reward. Alternatively, the user may select the predetermined product for which the user wants to receive the reward at appropriate time. The server 200 may be provided with a web page for registration or the like so that the user can easily perform the registration in the SNS-linked reward granting system.

Next, the server 200 transmits the SNS-linked reward granting application to the user terminal 100 via the communication unit 220 (step S202). Here, the SNS-linked reward granting application is a program for implementing the friend number counting module 111 and the update frequency counting module 112 that can operate on the user terminal 100.

The user terminal 100 receives the SNS-linked reward granting application via the communication unit 120 (step S203).

After receiving the SNS-linked reward granting application, the user terminal 100 starts the SNS-linked reward granting application and notifies the start to the server 200 (step S204). When the user information has not been transmitted to the server 200 in step S201, the user information is transmitted together. The content of the user information is as described above.

While it has not been shown in the flowchart, the user may update an article on the predetermined product at the registered SNS account through the user terminal 100, at a desired timing after starting the SNS-linked reward granting application in step S204. Here, at the time of updating the article, information, which can specify the predetermined product, such as a name of the predetermined product or a URL related to the predetermined product is included.

FIG. 8 is an example of a screen in a case of updating an article on a predetermined product in SNS. The details are as described above.

After starting the SNS-linked reward granting application, the control unit 110 of the user terminal 100 checks whether a predetermined time has elapsed (step S205). When the predetermined time has elapsed, the friend number counting module 111 counts the number of friends for the registered SNS account of the user terminal 100 (step S206). When the predetermined time has not elapsed, the process returns to step S205 again. While it has not been shown here, it is assumed that wait processing may be appropriately performed according to the system before returning to step S205.

When counting the number of friends in step S206, it may be checked whether the friends are active friends on the SNS, and only active friends may be counted. Whether it is active or not means whether the friend currently uses the SNS, and may be determined in accordance with whether the friend has exchanged a message with the user within a certain period of time, whether the friend has made comments on the user's articles or reactions, such as “like”, on the user's articles within a certain period of time, whether the friend has updated an article within a certain period of time, or the like. The details of the process of counting the number of friends of SNS are described later.

After counting the number of friends, the friend number counting module 111 checks whether the number of friends is equal to or more than a predetermined number of people (step S207). The predetermined number of people may be determined according to the predetermined product by the system and may be, for example, 50 or more people or 100 or more people.

When the number of friends is equal to or more than the predetermined number of people, an update frequency count module 112 of the user terminal 100 counts an update frequency of articles on the predetermined product (step S208). Here, when confirming the update frequency of the articles, the update frequency count module 112 may count only the articles whose contents are favorable to the predetermined product. Further, for example, a case where updating are performed a plurality of times per day may be counted only once, or a case where updating are performed a plurality of times within a certain period of time may be counted only once. The details of the process of confirming the update frequency of the articles on the predetermined product are described later. When the number of friends is less than the predetermined number of people, the process returns to step S205.

In the example of FIG. 8, it may be checked whether the content of the article relates to the predetermined product by using the name “Tabho” of the predetermined product or the URL “https://tabho.optim.co.jp” relating to the predetermined product as a keyword. Whether the content of the article is favorable may be determined by analyzing words or contexts included in the article of the predetermined article. In the article of Mike in FIG. 8, whether the article is favorable may be determined by the word such as “help”. Furthermore, when determining whether Jane's article is favorable, it may be determined that the article is favorable, by words such as “convenience”, “benefit” and the like. Here, the word registration or context analysis used for determining the content does not particularly limit the present invention and the existing technology may be used.

After counting the update frequency, the update frequency count module 112 checks whether the update frequency is equal to or more than a predetermined frequency (step S209).

When the update frequency of articles on the predetermined product is equal to or more than the predetermined frequency, the server 200 is requested to grant a reword for the predetermined product (step S210). Here, “the predetermined frequency or more” is determined by the update frequency within a predetermined period. For example, “the predetermined frequency or more” may be 10 times or more for the past month or 3 times or more for the past one week, and may be determined according to the predetermined product by the system. The predetermined time in step S205 needs to be equal to or shorter than the predetermined period. When the predetermined time is shorter than the predetermined period, the update frequency within the predetermined time is stored in the storage unit 130 so that the update frequency within the predetermined period can be check in step S209. Further, the reward for the predetermined product here may be a coupon or point that can be used for the predetermined product. For example, when the predetermined product is a certain paid web service, a point that can be used for the paid web service, one-year free license code or the like is considered as the reward. When the update frequency of the articles on the predetermined product is less than the predetermined frequency, the process returns to step S205.

Upon receiving the reward granting request, the server 200 grants the reward for the predetermined product to the user terminal 100 (step S211).

The user terminal 100 receives the reward for the predetermined product at the registered SNS account (step S212). The received reward may be used at a timing desired by the user.

After receiving the reward, the user terminal 100 checks whether to continue the SNS-linked reward granting process (step S213). The SNS-linked reward granting system may set whether the SNS-linked reward granting process can be continued after the reward is granted, in advance, according to the predetermined product and the content of the reward. For example, when the reward is a long-time free license code or the like, there is no need to continue the SNS-linked reward granting process, so the server 200 is notified of a registration release in the SNS-linked reward granting system (step S214). The SNS-linked reward granting application may be deleted together with the notification of the registration release in the SNS-linked reward granting system. When the reward is a point or the like that can be used for a paid web service, the SNS-linked reward granting process may be continued. In a case of continuing, the process returns to step S205 and continues the processing. Here, a condition for continuing the process, such as, for example, the continuation being impossible after the reward is granted three times, may be set according the system. In addition, the registration release in the SNS-linked reward granting system may be performed at any time by a release request from the user terminal 100. Further, the server 200 may also stop the SNS-linked reward granting system as necessary.

As described above, according to the present invention, when a user having a large number of friends and having an influence on the SNS updates articles for a predetermined product more than the predetermined frequency, it is possible to provide an SNS-linked reward granting system, an SNS-linked reward granting method, and an SNS-linked reward granting program that can grant a reward for the predetermined product, and are cost-effective for a company that wants to advertise the predetermined product. In addition, the process of counting the number of friends and the update frequency is performed at the side of the user terminal 100 so that the load at the side of the server 200 can be reduced when the number of users increases.

### Friend Number Counting Process

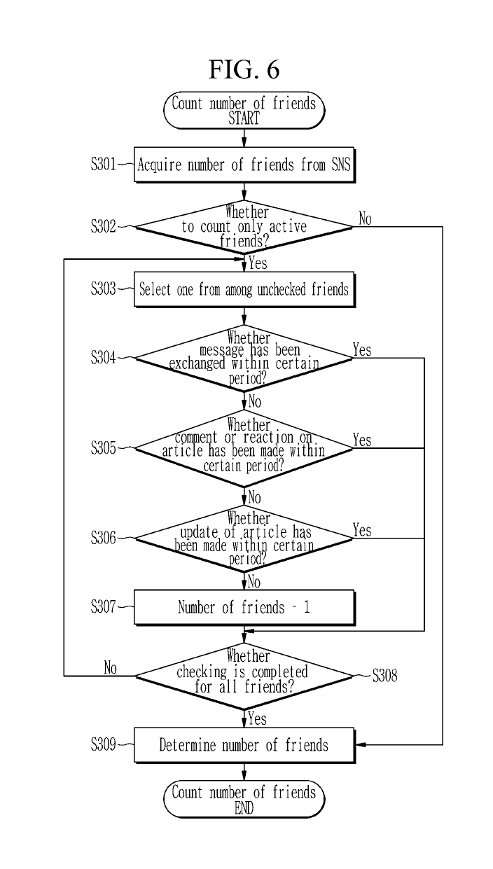

FIG. 6 is a flowchart of a process of counting the number of friends. This process is performed by a friend number counting module 111 when a user terminal 100 counts the number of friends, and is performed by a friend number counting module 211 when a server 200 counts the number of friends.

First, the number of friends of the user is acquired based on a type of SNS which has been registered as user information and an account of the SNS (step S301). In order to acquire the number of friends of the user, if necessary, an account relating to a predetermined product may be registered in the SNS in advance and the account may be registered in the user as the friend at the timing when the user registers in the SNS-linked reward granting system.

Next, it is checked whether to count only active friends as the number of friends (step S302). Whether it is active or not means whether the friend currently uses the SNS, and the active friend is a friend who is thought to perform the effective promotion when the user updates an article on the predetermined product. Even if the number of friends is large, the advertising effect cannot be expected when many of the friends are not using the SNS anymore. Therefore, only active friends are counted so that the reward can be granted to only a user with higher advertising effect.

In a case of counting only the active friends as the number of friends, one person is first selected from friends who are not identified about whether they are active (step S303). In a case where friends other than the active friends can be counted as the number of friends, the process proceeds to step S309.

In step S304, it is checked whether the user has exchanged a message with the selected friend within a certain period of time. Here, the message is assumed to be a character string, an image or the like which can be directly transmitted on the SNS. Further, in order to check whether the message exchange has been performed, user information may be used as necessary. Here, the method for checking whether the message exchange has been performed does not particularly limit the present invention, and the existing technology may be used. In addition, the certain period of time here is freely determined by the system and may be within three months or within one year.

Since it may be determined that the selected friend is active when the message has been transmitted and received within the certain period of time, the process proceeds to step S308. If the message has not been transmitted and received within the certain period of time, the process proceeds to next step S305.

Next, it is checked whether the selected friend has made a comments or a reaction on an article within the certain period of time (step S305). Here, the reaction is an act of leaving footprints on the article, such as pressing a “like” button on the article, sharing the article or the like. Further, in order to check whether the comment or reaction on the articles has been made, the user information may be used as necessary. Here, the method for checking whether the comment or reaction on the article has been made does not particularly limit the present invention and the existing technology may be used.

Since it may be determined that the selected friend is active when the comment or reaction on the article has been made within the certain period of time, the process proceeds to step S308. If the comment or reaction on the article has not been made within the certain period of time, the process proceeds to the next step S306.

Next, it is checked whether the selected friend has updated an article within the certain period (step S306). Here, in order to check whether the article has been updated, the user information may be as necessary. Further, the method for checking whether the article has been updated does not particularly limit the present invention and the existing technology may be used.

Since it may be determined that the selected friend is active when the article has been updated within the certain period of time, the process proceeds to step S308. If the article has not been updated within the certain period of time, the process proceeds to the next step S307.

When the message exchange, the comment or reaction on the article, and the update of the article have not been performed within the certain period of time, the friend is determined as inactive, and it is reduced by one person from the number of friends (step S307).

It is checked whether the proceeding of checking whether the selected friend is active has been completed for all the friends (step S308). If the checking proceeding has not been completed, the process returns to step S303 to continue the proceeding. If the checking proceeding has been completed, the process proceeds to step S309.

Finally, the number of friends is determined (step S309).

In the flowchart of FIG. 6, the processing order of steps S304, S305 and S306 is not necessarily in this order, and the processing order may be exchanged depending on the system.

Through the above process, the number of friends can be acquired for each of the case where only active friends are counted and the case whether the active friends and the friends other than the active friends are counted.

### Update Frequency Count Process

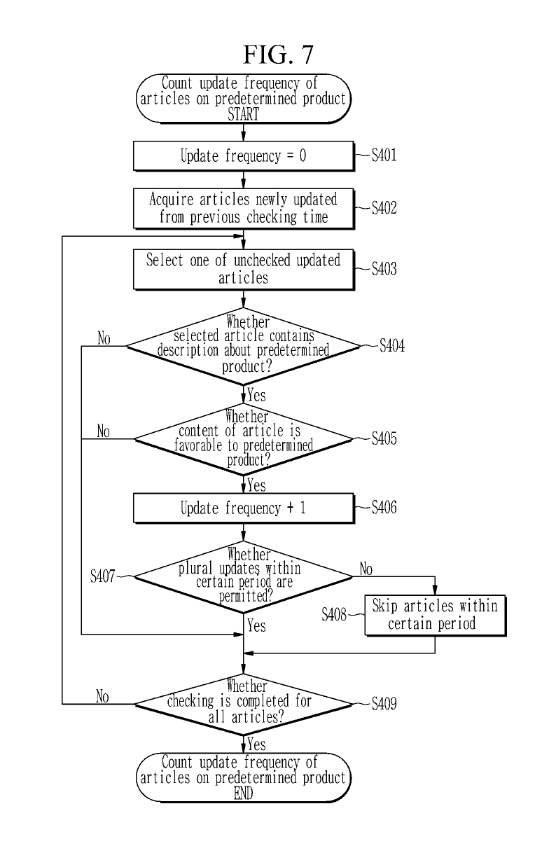

FIG. 7 is a flowchart of a process of counting an update frequency of articles on a predetermined product. This process is performed by an update frequency count module 112 when a user terminal 100 counts an update frequency of articles on a predetermined product, and is performed by an update frequency count module 112 when a server 200 counts the update frequency of the articles on the predetermined product. In the update frequency counting process, it is possible to count the number of updates within a predetermined time defined in step S103 of a flowchart shown in FIG. 3 or within a predetermined time defined in step S205 of a flowchart shown in FIG. 5.

First, a counter for the number of updates is set to zero (step S401).

Next, articles which are newly updated from a previous update frequency checking time are acquired (step S402). While it has not been shown in the flowchart, the process is terminated assuming that the number of updates is zero if there is no newly updated article.

When there are the newly updated articles, one of unchecked updated articles is selected (step S403). At this time, because the checking is performed from the newly updated articles, it is possible to efficiently perform a processing of a case where the update is not permitted a plurality of times within a certain period of time as described later.

It is checked whether the selected article contains a description about the predetermined product (step S404). In an example shown in FIG. 8, it may be checked whether the content of the article relates to the predetermined product by using the name “Tabho” of the predetermined product or the URL “https://tabho.optim.co.jp” relating to the predetermined product as a keyword.

If the article contains the description about the predetermined product, the process proceeds to the next step S405. If the article contains no description about the predetermined product, the process proceeds to step 409.

Next, it is checked whether the content of the article is favorable to the predetermined product (step S405). Whether the processing of step S405 is performed may be set by the system as necessary, and if not necessary, the process may skip the processing and proceed to step S406. Whether the content of the article is favorable may be determined by analyzing a word or context included in the article on the predetermined product. In the article of Mike shown in FIG. 8, it can be determined that the article is favorable, by the word and context such as “help”. Further, when determining whether Jane's article is favorable, it may be determined that the article is favorable, by words or contexts such as “convenience”, “benefit” and the like. Here, the word registration or context analysis used for determining the content does not particularly limit the present invention and the existing technology may be used.

When the content of the article is favorable to the predetermined article, the process proceeds to the next step S406. When the content of the article is not favorable to the predetermined article, the process proceeds to step S409.

When the article contains the description for the predetermined product and the content of the article is favorable to the predetermined product, one is added to the counter for the number of updates (step S406). As described above, checking whether the content is favorable to the predetermined product may be performed only when necessary according to the setting of the system.

After updating the counter, it is checked whether updates which are performed a plurality of times within a certain period of time can be permitted (step S407). The permission, for example, such as an update being counted only once when the update is performed a plurality of times a day, or an update being counted only once when the update is performed a plurality of times within a certain period of time may be arbitrarily set by the system.

When the updates which are performed a plurality of times within the certain period of time is not permitted, the updates which are performed within the certain period of time are counted only once. Therefore, articles updated within the certain period of time are skipped and the checking is completed (step S408). When the updates which are performed a plurality of times within the certain period of time is permitted, the process proceeds to the next step S409.

It is checked whether the proceeding of checking the number of updates has been completed for all the articles (step S409). If the checking proceeding has not been completed, the process returns to step S403 to continue the proceeding. If the checking proceeding has been completed, the counter for the number of updates at that time is stored and the process is terminated. Through the above process, it is possible to count the number of updates of articles on the predetermined product within the predetermined time. Further, in response to a request from a company that wishes to advertise the predetermined product, a response of performing the count only when the content of the article is favorable to the predetermined product, counting updates performed within a certain period of time only once, or the like can be performed.

The means and functions described above are realized by reading and executing a predetermined program by a computer (including a CPU, an information processing device, or various terminals). The program is provided, for example, in a form recorded in a computer-readable recording medium such as a flexible disk, a CD (e.g., CD-ROM or the like), a DVD (DVD-ROM, DVD-RAM, or the like), a compact memory, or the like. In this case, the computer reads the program from the recording medium and transfers the program to an internal storage unit or an external storage unit so as to be stored and executed. Furthermore, the program may be, for example, recorded in a storage device (recording medium) such as a magnetic disk, an optical disk, an optical magnetic disk, or the like in advance and be provided from the recording medium to the computer through a communication line.

While the embodiments of the present invention have been described above, the present invention is not limited to the above-described embodiments. In addition, the effects described in the embodiments of the present invention are merely a list of the most preferable effects produced by the present invention, and the effects of the present invention are limited to those described in the embodiments of the present invention.

### DESCRIPTION OF REFERENCE NUMBERS

100: user terminal, 200: server, 300: communication line

What is claimed is:

1. An SNS-linked reward granting system for granting a reward in conjunction with SNS (Social Networking Service), comprising:
a friend number counting unit that counts a number of only active friends among friends of an SNS user, the active friends each having made a comment or reaction in the SNS within a predetermined period of time; and
an update frequency counting unit that counts an update frequency of articles on a predetermined product, which are written in the SNS by the SNS user,
wherein a reward for the predetermined product is granted to the SNS user when the number of friends counted by the friend number counting unit is equal to or more than a predetermined number of people and the update frequency counted by the update frequency counting unit is equal to or more than a predetermined frequency, and
wherein in a case where the SNS user uses a plurality of SNSs, the friend number counting unit counts the number of friends by a total sum of the number of active friends in each of the plurality of SNSs, and counts, when a same friend exists in multiple SNSs, duplicate friends only once.

2. The SNS-linked reward granting system of claim 1, wherein the reward is a coupon or a point.

3. The SNS-linked reward granting system of claim 1, wherein the update frequency counting unit counts only updates of articles whose contents are favorable to the predetermined product.

4. The SNS-linked reward granting system of claim 1, wherein the update frequency counting unit counts updates, which are performed a plurality of times a day, only once.

5. An SNS-linked reward granting method for granting a reward in conjunction with SNS, comprising:
counting a number of only active friends among friends of an SNS user, the active friends each having made a comment or reaction in the SNS within a predetermined period of time; and
counting an update frequency of articles on a predetermined product, which are written in the SNS by the SNS user,
wherein a reward for the predetermined product is granted to the SNS user when the number of friends counted in the friend number counting step is equal to or more than a predetermined number of people and the update frequency counted in the update frequency counting step is equal to or more than a predetermined frequency, and
wherein in a case where the SNS user uses a plurality of SNSs, the friend number counting unit counts the number of friends by a total sum of the number of active friends in each of the plurality of SNSs, and counts, when a same friend exists in multiple SNSs, duplicate friends only once.

6. A program for causing an SNS-linked reward granting method for granting a reward in conjunction with SNS to execute:
counting a number of only active friends among friends of an SNS user, the active friends each having made a comment or reaction in the SNS within a predetermined period of time; and
counting an update frequency of articles on a predetermined product, which are written in the SNS by the SNS user,
wherein a reward for the predetermined product is granted to the SNS user when the number of friends counted in the friend number counting step is equal to or more than a predetermined number of people and the update frequency counted in the update frequency counting step is equal to or more than a predetermined frequency, and
wherein in a case where the SNS user uses a plurality of SNSs, the friend number counting unit counts the number of friends by a total sum of the number of active friends in each of the plurality of SNSs, and counts, when a same friend exists in multiple SNSs, duplicate friends only once.
